(19) United States
(12) Patent Application Publication
(10) Pub. No.: US 2021/0104710 A1
(43) Pub. Date: Apr. 8, 2021

(54) ELECTROCHEMICAL CELL

(71) Applicant: Seiko Instruments Inc., Chiba-shi (JP)

(72) Inventors: Shunji WATANABE, Chiba-shi (JP); Kazumi Tanaka, Chiba-shi (JP); Nagayuki Kimura, Chiba-shi (JP); Tsuneaki Tamachi, Chiba-shi (JP)

(21) Appl. No.: 17/034,691

(22) Filed: Sep. 28, 2020

(30) Foreign Application Priority Data
Oct. 7, 2019 (JP) 2019-184458

(51) Int. Cl. H01M 2/02; H01M 2/08; H01G 9/048; H01G 9/10

(52) U.S. Cl. CPC H01M 2/0287; H01M 2/08; H01M 2/026; H01M 2/0222; H01G 9/145; H01G 9/10; H01M 2002/0297; H01M 2220/30; H01G 9/048

(57) ABSTRACT

An electrochemical cell includes an electrode body that has a plurality of electrodes stacked on each other in a direction of a battery axis O, and an exterior body that has a first laminate member and a second laminate member, and that internally accommodates the electrode body. The exterior body includes an accommodation portion that internally accommodates the electrode body, and a sealing portion in which the first laminate member and the second laminate member are joined to each other in a state where the first laminate member and the second laminate member overlap each other so as to seal an inside of the accommodation portion. The accommodation portion includes a top wall portion and a bottom wall portion which face each other with the electrode body interposed therebetween in the direction of the battery axis, and a cylindrical peripheral wall portion which surrounds the electrode body from an outer side in a radial direction. The sealing portion is formed into a cylindrical shape which is bent along the peripheral wall portion and surrounds the peripheral wall portion over an entire periphery from the outer side in the radial direction, and is in contact with the peripheral wall portion from the outer side in the radial direction.

### RELATED APPLICATIONS

This application claims priority to Japanese Patent Application No. 2019-184458, filed on Oct. 7, 2019, the entire content of which is incorporated herein by reference.

### BACKGROUND OF THE INVENTION

### 1. Field of the Invention

The present invention relates to an electrochemical cell.

### 2. Description of the Related Art

In the related art, an electrochemical cell such as a lithium-ion secondary battery and an electrochemical capacitor has been widely used as a power source for a small device such as a smartphone, a wearable device, and a hearing aid.

In recent years, as this type of the electrochemical cell, a so-called laminate-type electrochemical cell is known in which a laminate film is used for an exterior body that internally accommodates an electrode body. The laminate-type electrochemical cell is known as the electrochemical cell that achieves a smaller size, a more freely designed shape, and higher capacity.

For example, PTL 1 discloses an electrochemical cell having an electrode body, a first laminate member, and a second laminate member. An exterior body that accommodates the electrode body is provided between the first laminate member and the second laminate member.

The exterior body includes an accommodation portion that accommodates the electrode body, and a sealing portion that is bent along an outer periphery of the accommodation portion. The sealing portion is formed in such a way that a welded portion between the first laminate member and the second laminate member is bent and molded along the outer periphery of the accommodation portion by using a molding die.

### CITATION LIST

### Patent Literature

[PTL 1] Japanese Unexamined Patent Application, First Publication No. 2018-85214

### SUMMARY OF THE INVENTION

### Technical Problem

The laminate-type electrochemical cell in the related art adopts a coin type in which the sealing portion of the exterior body is bent along the outer periphery of the accommodation portion. Accordingly, compared to a laminate battery formed in a rectangular shape in a plan view, the laminate-type electrochemical cell achieves a decreased size and improved volumetric efficiency.

The volumetric efficiency means a ratio of a volume occupied by electrodes to a volume of a whole battery, that is, “electrode portion volume/whole battery volume”.

However, the sealing portion is formed through bending molding by using the molding die. Accordingly, due to a structure of the molding die, there is a disadvantage in that an annular gap space is formed between the outer periphery of the accommodation portion and the sealing portion. Therefore, the diameter increases as much as a space of the gap space. Consequently, it is difficult to further decrease the diameter, and there is room for improvement.

The present invention is made in view of the above-described circumstances, and an object thereof is to provide a laminate-type electrochemical cell which can achieve a decreased diameter, and which can achieve further improved volumetric efficiency.

### Solution to Problem

(1) According to the present invention, there is provided an electrochemical cell including an electrode body that has a plurality of electrodes stacked on each other in a direction of a battery axis, and an exterior body that has a first laminate member and a second laminate member, and that internally accommodates the electrode body. The exterior body includes an accommodation portion that is formed by disposing the first laminate member and the second laminate member with the electrode body interposed therebetween in the direction of the battery axis, and that internally accommodates the electrode body, and a sealing portion in which the first laminate member and the second laminate member are joined to each other in a state where the first laminate member and the second laminate member overlap each other so as to seal an inside of the accommodation portion. The accommodation portion includes a top wall portion and a bottom wall portion which face each other with the electrode body interposed therebetween in the direction of the battery axis, and a cylindrical peripheral wall portion which surrounds the electrode body from an outer side in a radial direction. The sealing portion is formed into a cylindrical shape which is bent along the peripheral wall portion and surrounds the peripheral wall portion over an entire periphery from the outer side in the radial direction, and is in contact with the peripheral wall portion from the outer side in the radial direction.

According to the electrochemical cell of the present invention, the sealing portion that seals the inside of the accommodation portion is formed in the cylindrical shape which is bent along the peripheral wall portion in the accommodation portion and surrounds the peripheral wall portion over the entire periphery from the outer side in the radial direction. Moreover, the sealing portion is brought into contact with the peripheral wall portion from the outer side in the radial direction. In this manner, the sealing portion can be disposed to surround the peripheral wall portion without forming an annular gap between the peripheral wall portion and the sealing portion. Therefore, as much as the gap can be omitted, a diameter of the whole electrochemical cell can be decreased, compared to a diameter in the related art.

In particular, the diameter of the whole electrochemical cell can be decreased without changing the size of the accommodation portion that accommodates the electrode body. Accordingly, a ratio of a volume occupied by the electrode body to a volume of the whole electrochemical cell can be improved. Therefore, it is possible to achieve improved volumetric efficiency.

In addition, the exterior body is formed using the first laminate member and the second laminate member which are thin. Accordingly, each thickness itself of the peripheral wall portion and the sealing portion can be decreased. In this regard, it is also easy to decrease the diameter of the electrochemical cell.

Furthermore, the first laminate member and the second laminate member are joined to each other through heat welding, for example. In this manner, the sealing portion can be formed, and moreover, the sealing portion is bent along the peripheral wall portion. Therefore, it is possible to effectively prevent external disturbances such as dust and water from entering the inside of the accommodation portion from the outside through a portion between the first laminate member and the second laminate member. Therefore, it is possible to provide the electrochemical cell which shows stable operation reliability.

(2) The sealing portion may have a wrinkle portion extending in a circumferential direction over the entire periphery of the sealing portion while repeatedly protruding outward in the radial direction and protruding inward in the radial direction.

In this case, the wrinkle portion can be used to absorb stress strain generated when the sealing portion is bent. Accordingly, the sealing portion can be formed through drawing molding, for example. Therefore, the sealing portion can be bent while an equal external force is applied over the entire periphery of the sealing portion, and the whole sealing portion can be brought into uniform contact with the peripheral wall portion. Therefore, it is possible to achieve a further decreased diameter of the electrochemical cell.

(3) The wrinkle portion may be formed so that a wrinkle depth is deepened toward an opening end side in the sealing portion.

In this case, even in a case where a length (height) of the sealing portion along the direction of the battery axis is long, the sealing portion can be properly formed through the drawing molding, for example. The sealing portion is easily brought into contact with the peripheral wall portion without forming a gap between the peripheral wall portion and the sealing portion.

### Advantageous Effects of Invention

According to the present invention, it is possible to provide the laminate-type electrochemical cell which can achieve the decreased diameter and the further improved volumetric efficiency. Therefore, it is possible to provide a high performance electrochemical cell which can achieve a decreased diameter, a decreased size, a decreased weight, and a higher volume capacity density.

### BRIEF DESCRIPTION OF THE DRAWINGS

FIG. 1 is a perspective view illustrating an embodiment of a secondary battery (electrochemical cell) according to the present invention.

FIG. 2 is a longitudinal sectional view of the secondary battery taken along line A-A illustrated in FIG. 1.

FIG. 3 is a longitudinal sectional view of the secondary battery in which a portion surrounded by a virtual circle B illustrated in FIG. 2 is enlarged.

FIG. 4 is an exploded perspective view of the secondary battery illustrated in FIG. 2.

FIG. 5 is a longitudinal sectional view of an electrode body taken along line C-C illustrated in FIG. 4.

FIG. 6 is a development view of a positive electrode illustrated in FIG. 5 before being wound.

FIG. 7 is a development view of a negative electrode illustrated in FIG. 5 before being wound.

FIG. 8 is a view illustrating a step in a manufacturing process of the secondary battery illustrated in FIG. 1, and is a perspective view of a molding-unfinished battery before a sealing portion is bent and molded.

FIG. 9 is a perspective view when the molding-unfinished battery illustrated in FIG. 8 is viewed from another viewpoint.

FIG. 10 is a sectional view illustrating a state where the molding-unfinished battery illustrated in FIG. 8 is set in a first die of a molding die.

FIG. 11 is a sectional view illustrating a state where the sealing portion of the molding-unfinished battery is clamped and fixed between the first die and a second die after the state illustrated in FIG. 10.

FIG. 12 is a sectional view illustrating a state where a punch portion is lifted after the state illustrated in FIG. 11.

FIG. 13 is a sectional view illustrating a state where the sealing portion is subjected to bending molding by using a molding portion of the punch portion after the state illustrated in FIG. 12.

FIG. 14 is a sectional view illustrating a state where a molding-finished battery having the sealing portion subjected to the bending molding is unloaded from the molding die after the state illustrated in FIG. 13.

FIG. 15 is a sectional view illustrating a state where the molding-finished battery is set in a drawing molding die after the state illustrated in FIG. 14.

FIG. 16 is a sectional view illustrating a state where the sealing portion of the molding-finished battery is subjected to drawing molding after the state illustrated in FIG. 15.

FIG. 17 is a sectional view illustrating a modification example of the secondary battery according to the present invention.

### DETAILED DESCRIPTION OF THE PREFERRED EMBODIMENTS

Hereinafter, embodiments of an electrochemical cell according to the present invention will be described with reference to the drawings. In the present embodiment, as an example of the electrochemical cell, a lithium-ion secondary battery (hereinafter, simply referred to as a secondary battery) which is a type of a non-aqueous electrolyte secondary battery will be described.

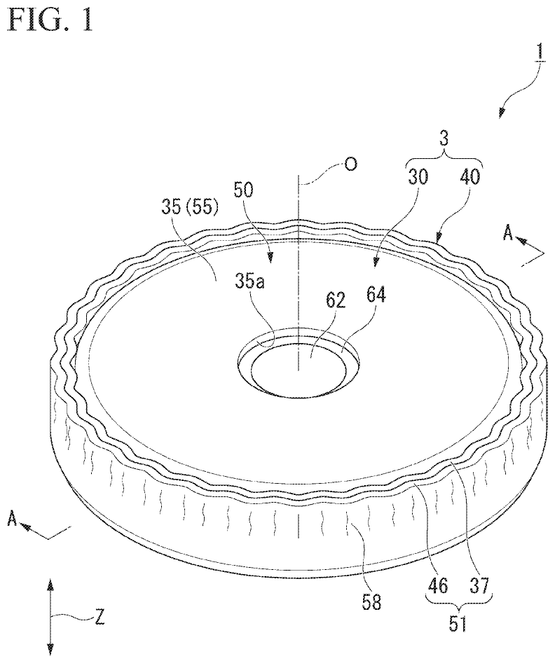

As illustrated in FIGS. 1 to 4, a secondary battery 1 according to the present embodiment is a so-called coin-type (button-type) battery, and mainly includes a plurality of electrodes stacked on each other along a direction of a battery axis O, that is, an electrode body 2 having a positive electrode 10 and a negative electrode 20, and an exterior body 3 formed of a laminate film and internally accommodating the electrode body 2. In each drawing, the electrode body 2 is illustrated in an appropriately simplified manner.

In the present embodiment, an axis extending along an upward-downward direction through a center of the electrode body 2 will be referred to as the battery axis O. In addition, in a plan view from the direction of the battery axis O, a direction intersecting with the battery axis O will be referred to as a radial direction, and a direction turning around the battery axis O will be referred to as a circumferential direction.

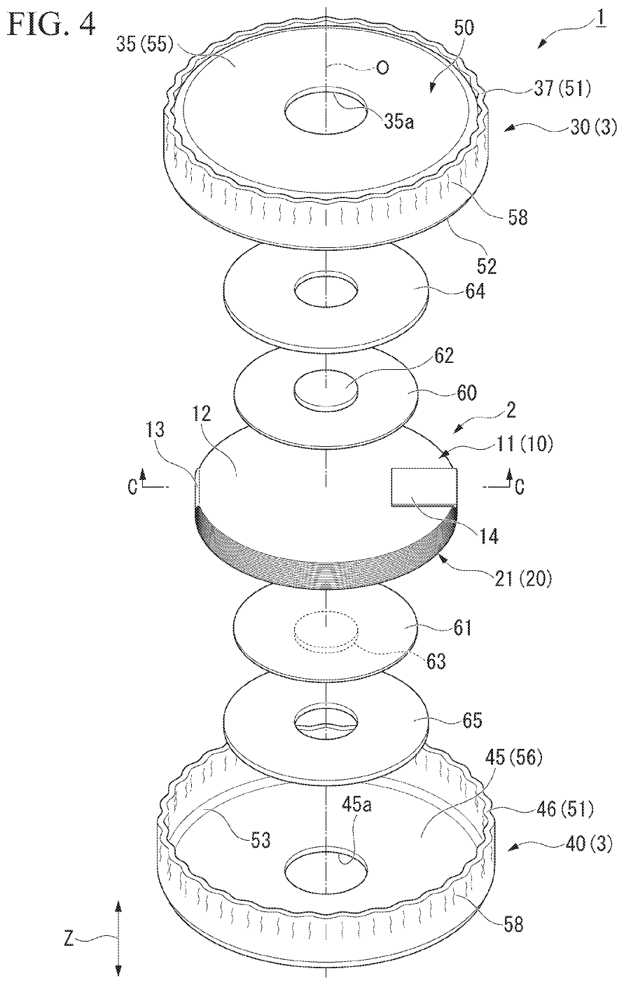

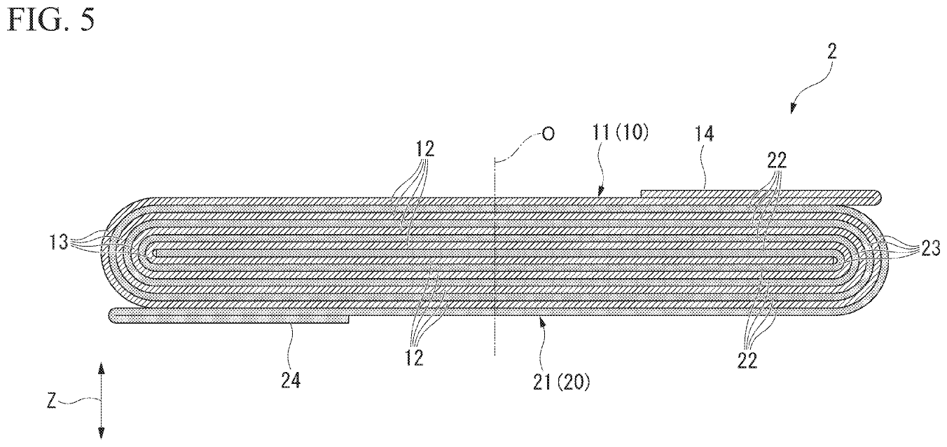

As illustrated in FIGS. 4 and 5, the electrode body 2 is a so-called stacked electrode in which the positive electrode 10 and the negative electrode 20 are stacked with a separator (not illustrated) interposed therebetween.

The electrode body 2 is formed to have a circular outer shape in a plan view. However, the outer shape of the electrode body 2 is not limited to this case, and may be other shapes. For example, an elliptical shape, an oval shape, or a rhombic shape may be adopted, and the outer shape may be appropriately changed.

The positive electrode 10 and the negative electrode 20 according to the present embodiment are wound with the separator interposed therebetween so that both of these are alternately stacked. However, the configuration is not limited to this case. For example, the positive electrode 10 and the negative electrode 20 may be respectively folded in a zigzag shape in directions intersecting with each other so that both of these are alternately stacked. Furthermore, the electrode body 2 may be a so-called pellet-type electrode body in which the positive electrode 10 and the negative electrode 20 are provided on both surfaces of the separator.

A structure of the electrode body 2 will be briefly described.

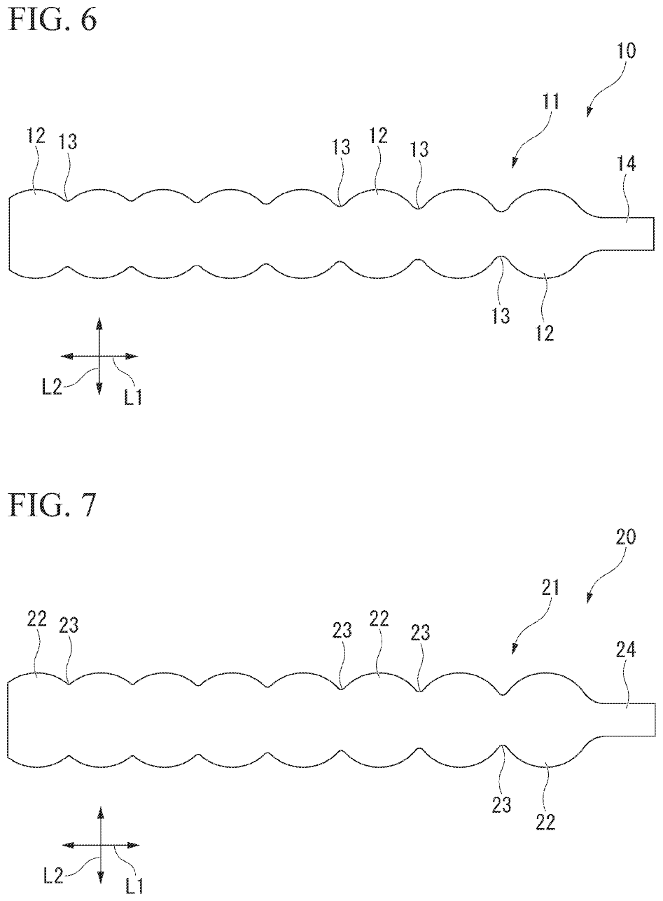

As illustrated in FIG. 6, the positive electrode 10 includes a positive electrode current collector 11 formed in a strip shape extending along a first direction L1 in an unwound and developed state, and a positive electrode active material layer (not illustrated) formed on both surfaces of the positive electrode current collector 11.

For example, the positive electrode current collector 11 is formed of a metal material such as aluminum and stainless steel in a thin sheet shape, and includes a plurality of positive electrode main bodies 12 and a plurality of positive electrode connection pieces 13. The positive electrode main bodies 12 are formed in a disc shape, and are disposed at an interval to be aligned in a row in the first direction L1. In the illustrated example, the number of positive electrode main bodies 12 is eight. However, the number of positive electrode main bodies 12 is not limited to eight, and may be appropriately changed.

The positive electrode connection piece 13 is disposed between the positive electrode main bodies 12 adjacent to each other in the first direction L1, and connects the adjacent positive electrode main bodies 12 to each other. Therefore, in the illustrated example, the number of the positive electrode connection pieces 13 is seven. The positive electrode connection piece 13 is formed such that the width along a second direction L2 orthogonal to the first direction L1 in a plan view is narrower than the width along the second direction L2 of the positive electrode main body 12.

An outer edge of the positive electrode connection piece 13 is formed in an arcuate shape which is recessed inward in a plan view, and is continuously disposed to be smoothly connected to the arcuate outer edge of the positive electrode main body 12. However, the outer edge of the positive electrode connection piece 13 does not necessarily have the arcuate shape, and may have a linear shape, for example.

In particular, a dimension of the respective positive electrode connection pieces 13 along the first direction L1 increases toward the positive electrode connection piece 13 disposed on an outer peripheral side of the electrode body 2 in a wound state. In this manner, an interval between the pair of positive electrode main bodies 12 adjacent to each other in the first direction L1 in a developed state increases as the positive electrode main body 12 is located on the outer peripheral side in the wound state.

Out of the plurality of positive electrode main bodies 12, the positive electrode main body 12 located at one end position in the first direction L1 (that is, the positive electrode main body 12 disposed on an outermost periphery in the wound state) has a positive electrode terminal tab 14 formed to further extend outward in the first direction L1.

In the present embodiment, the positive electrode main body 12 located at the other end position in the first direction L1 will be referred to as the first-stage positive electrode main body 12. Then, the other positive electrode main bodies 12 will be sequentially referred to as the second-stage, third-stage, fourth-stage, fifth-stage, sixth-stage, seventh-stage, and eighth-stage positive electrode main bodies 12 toward the positive electrode main body 12 having the positive electrode terminal tab 14. Therefore, the positive electrode main body 12 having the positive electrode terminal tab 14 corresponds to the eighth-stage positive electrode main body 12.

The positive electrode active material layer is formed on both surfaces of the positive electrode current collector 11 excluding the positive electrode terminal tab 14. The positive electrode active material layer contains a positive electrode active material, a conductive auxiliary agent, a binding agent, and a thickening agent, and is formed of composite metal oxide such as lithium cobalt oxide and lithium nickel oxide, for example.

Examples of the conductive auxiliary agent include carbon blacks, carbon materials, and fine metal powder. Examples of the binding agent include resin materials such as polyvinylidene fluoride (PVDF), styrene butadiene rubber (SBR) and polytetrafluoroethylene (PTFE). Examples of the thickening agent include resin materials such as carboxymethyl cellulose (CMC).

As illustrated in FIG. 7, the negative electrode 20 includes a negative electrode current collector 21 formed in a strip shape extending along the first direction L1 in the unwound and developed state, and a negative electrode active material layer (not illustrated) formed on both surfaces of the negative electrode current collector 21.

For example, the negative electrode current collector 21 is formed of a metal material such as copper, nickel, and stainless steel in a thin sheet shape, and includes a plurality of negative electrode main bodies 22 and a plurality of negative electrode connection pieces 23. The negative electrode main bodies 22 are formed in a disc shape as in the positive electrode main body 12, and are disposed at an interval to be aligned in a row in the first direction L1. In the illustrated example, the number of the negative electrode main bodies 22 is eight, which corresponds to the number of the positive electrode main bodies 12. However, the number of the negative electrode main bodies 22 is not limited to eight, and may be appropriately changed corresponding to the number of the positive electrode main bodies 12.

The negative electrode connection piece 23 is disposed between the negative electrode main bodies 22 adjacent to each other in the first direction L1, and connects the adjacent negative electrode main bodies 22 to each other. Therefore, in the illustrated example, the number of the negative electrode connection pieces 23 is seven. The negative electrode connection piece 23 is formed such that the width along the second direction L2 orthogonal to the first direction L1 in a plan view is narrower than the width along the second direction L2 of the negative electrode main body 22.

The outer edge of the negative electrode connection piece 23 is formed in an arcuate shape recessed inward in a plan view, and is continuously disposed to be smoothly connected to the arcuate outer edge of the negative electrode main body 22. However, the outer edge of the negative electrode connection piece 23 does not necessarily have the arcuate shape, and may have a linear shape, for example.

In particular, the dimension of the respective negative electrode connection pieces 23 along the first direction L1 increases toward the negative electrode connection piece 23 disposed on the outer peripheral side of the electrode body 2 in the wound state. In this manner, the interval between the pair of negative electrode main bodies 22 adjacent to each other in the first direction L1 in the developed state increases as the negative electrode main body 22 is located on the outer peripheral side in the wound state.

Out of the plurality of negative electrode main bodies 22, the negative electrode main body 22 located at one end position in the first direction L1 (that is, the negative electrode main body 22 disposed on the outermost periphery in the wound state) has a negative electrode terminal tab 24 formed to further extend outward in the first direction L1.

In the present embodiment, the negative electrode main body 22 located at the other end position in the first direction L1 will be referred to as the first-stage negative electrode main body 22. Then, the other negative electrode main bodies 22 will be sequentially referred to as the second-stage, third-stage, fourth-stage, fifth-stage, sixth-stage, seventh-stage, and eighth-stage negative electrode main bodies 22 toward the negative electrode main body 22 having the negative electrode terminal tab 24. Therefore, the negative electrode main body 22 having the negative electrode terminal tab 24 corresponds to the eighth-stage negative electrode main body 22.

The negative electrode 20 configured as described above has the outer shape which is similar to the outer shape of the above-described positive electrode 10. However, an outer shape size of the positive electrode 10 is formed to be slightly smaller (one size smaller) than an outer shape size of the negative electrode 20.

The negative electrode active material layer is formed on both surfaces of the negative electrode current collector 21 excluding the negative electrode terminal tab 24. The negative electrode active material layer contains a negative electrode active material, a conductive auxiliary agent, a binding agent, and a thickening agent, and is formed of a carbon material such as graphite.

Examples of the conductive auxiliary agent include carbon blacks, carbon materials, and fine metal powder. Examples of the binding agent include resin materials such as polyvinylidene fluoride (PVDF), styrene butadiene rubber (SBR) and polytetrafluoroethylene (PTFE). Examples of the thickening agent include resin materials such as carboxymethyl cellulose (CMC).

The positive electrode 10 and the negative electrode 20 which are configured as described above are wound with the separator as described above interposed therebetween so that both of these are alternately stacked.

Specifically, for example, in a state where the positive electrode 10 illustrated in FIG. 6 and the negative electrode 20 illustrated in FIG. 7 are disposed along the first direction L1 so that the positive electrode terminal tab 14 and the negative electrode terminal tab 24 are disposed on mutually opposite sides, the first-stage positive electrode main body 12 and the first-stage negative electrode main body 22 are superimposed on each other. Subsequently, the positive electrode 10 and the negative electrode 20 are repeatedly wound in the same direction, starting from the first-stage positive electrode main body 12 and the first-stage negative electrode main body 22 which are superimposed on each other. In this manner, the positive electrode main body 12 and the negative electrode main body 22 can be alternately stacked in the direction of the battery axis O to be superimposed on each other, and the electrode body 2 illustrated in FIG. 5 can be configured. The separator is not illustrated in FIG. 5.

In the electrode body 2 obtained by the above-described winding, as illustrated in FIG. 5, the eighth-stage positive electrode main body 12 having the positive electrode terminal tab 14 is located in the uppermost stage, and eighth-stage negative electrode main body 22 having the negative electrode terminal tab 24 is located in the lowermost stage. Therefore, the electrode body 2 is accommodated inside the exterior body 3 in a state where the positive electrode terminal tab 14 faces upward and the negative electrode terminal tab 24 faces downward.

In the electrode body 2 illustrated in FIG. 5, focusing on the positive electrode 10, the positive electrode 10 is wound so that the positive electrode main bodies 12 are aligned downward from above to be parallel to each other in the direction of the battery axis O in the order of the eighth stage, the sixth stage, the fourth stage, the second stage, the first stage, the third stage, the fifth stage, and the seventh stage. In contrast, focusing on the negative electrode 20, the negative electrode 20 is wound so that the negative electrode main bodies 22 are aligned downward from above to be parallel to each other in the direction of the battery axis O in the order of the seventh stage, the fifth stage, the third stage, the first stage, the second stage, the fourth stage, the sixth stage, and the eighth stage.

As illustrated in FIGS. 1 to 4, the exterior body 3 includes a first laminate member 30 and a second laminate member 40 which are formed of a laminate film.

The exterior body 3 includes an accommodation portion 50 formed so that the first laminate member 30 and the second laminate member 40 are arranged in the direction of the battery axis O with the electrode body 2 interposed therebetween, and internally accommodating the electrode body 2, and a sealing portion 51 in which the first laminate member 30 and the second laminate member 40 are joined to each other in a state where the first laminate member 30 and the second laminate member 40 overlap each other, and which seals the inside of the accommodation portion 50. In this manner, the exterior body 3 accommodates the electrode body 2 in a state where the electrode body 2 is sealed inside the accommodation portion 50. The inside of the accommodation portion 50 is filled with an electrolyte solution (not illustrated).

The accommodation portion 50 includes a top wall portion 55 and a bottom wall portion 56 which face each other with the electrode body 2 interposed therebetween in the direction of the battery axis O, and an annular peripheral wall portion 57 which surrounds the electrode body 2 from the outer side in the radial direction.

The sealing portion 51 is bent along the peripheral wall portion 57, is formed in an annular shape which surrounds the peripheral wall portion 57 over the entire periphery from the outer side in the radial direction, and comes into contact with the peripheral wall portion 57 from the outer side in the radial direction.

The exterior body 3 including the accommodation portion 50 and the sealing portion 51 will be described in detail below.

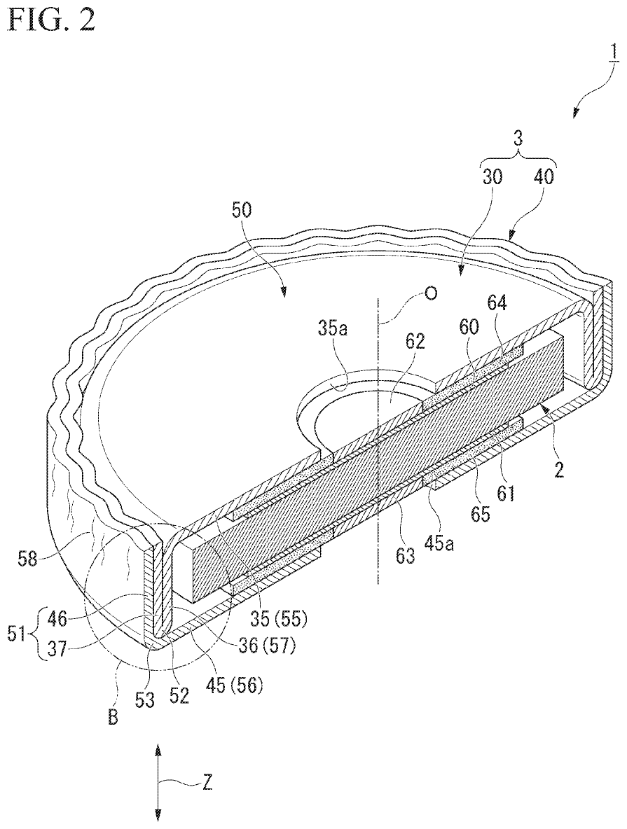

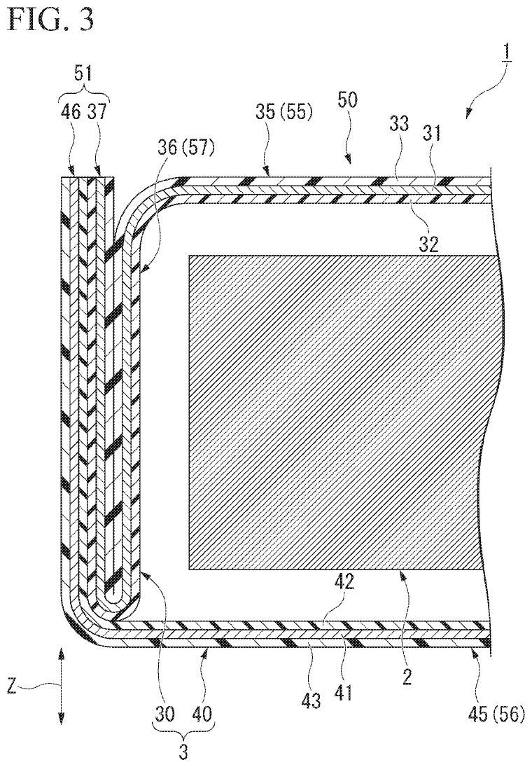

As illustrated in FIGS. 2 and 3, the first laminate member 30 is a member that mainly covers the electrode body 2 from above. The first laminate member 30 has a metal layer 31, and an inner resin layer 32 and an outer resin layer 33 which cover both surfaces of the metal layer 31. The inner resin layer 32 and the outer resin layer 33 are densely joined to both surfaces of the metal layer 31 via a joining layer (not illustrated) by heat welding or adhesion, for example. In each drawing, the metal layer 31, the inner resin layer 32, and the outer resin layer 33 are appropriately omitted in the illustration.

For example, the metal layer 31 is formed of a metal material suitable for blocking external air or water vapor, such as stainless steel and aluminum.

For example, the inner resin layer 32 is formed using a thermoplastic resin such as polyethylene and polypropylene of polyolefin. As the polyolefin, it is possible to use any material of high-pressure low-density polyethylene (LDPE), low-pressure high-density polyethylene (HDPE), inflation polypropylene (IPP) film, non-oriented polypropylene (CPP) film, biaxially oriented polypropylene (OPP) film, and linear short-chain branched polyethylene (L-LDPE, metallocene catalyst specification). In particular, it is preferable to use a polypropylene resin.

For example, the outer resin layer 33 is formed using the above-described polyolefin, polyester such as polyethylene terephthalate, or nylon.

The first laminate member 30 is formed in a topped double cylinder including a top wall portion 35 having a circular shape in a plan view which covers the electrode body 2 from above, a cylindrical peripheral wall portion 36 extending downward from an outer peripheral edge portion of the top wall portion 35 and surrounding the electrode body 2 from the outer side in the radial direction, and a cylindrical first sealing portion 37 surrounding the peripheral wall portion 36 from the outer side in the radial direction.

In the illustrated example, a height position of an upper end opening end of the first sealing portion 37 is the same as a height position of the top wall portion 35. In this manner, the first sealing portion 37 is formed without protruding upward of the top wall portion 35.

The second laminate member 40 is a member that mainly covers the electrode body 2 from below. The second laminate member 40 has a metal layer 41, and an inner resin layer 42 and an outer resin layer 43 which cover both surfaces of the metal layer 41. The inner resin layer 42 and the outer resin layer 43 are densely joined to both surfaces of the metal layer 41 via a joining layer (not illustrated) by heat welding or adhesion, for example.

The material of the metal layer 41, the inner resin layer 42, and the outer resin layer 43 is the same as the material of the metal layer 31, the inner resin layer 32, and the outer resin layer 33 of the first laminate member 30. In addition, in each drawing, the metal layer 41, the inner resin layer 42, and the outer resin layer 43 are appropriately omitted in the illustration.

The second laminate member 40 is formed in a bottomed cylindrical shape including a bottom wall portion 45 that covers the electrode body 2 from below, and a cylindrical second sealing portion 46 extending upward from the outer peripheral edge portion of the bottom wall portion 45 and further surrounding the first sealing portion 37 from the outer side in the radial direction.

In the illustrated example, the height position of the upper end opening end of the second sealing portion 46 is the same as the height position of the upper end opening end of the first sealing portion 37.

The exterior body 3 is configured to include the first laminate member 30 and the second laminate member 40 which are configured as described above.

Specifically, the top wall portion 35 and the peripheral wall portion 36 of the first laminate member 30 respectively function as the top wall portion 55 and the peripheral wall portion 57 which serve as the accommodation portion 50. In addition, the bottom wall portion 45 of the second laminate member 40 functions as the bottom wall portion 56 which serves as the accommodation portion 50. Furthermore, the first sealing portion 37 in the first laminate member 30 and the second sealing portion 46 in the second laminate member 40 function as the sealing portion 51.

The first sealing portion 37 and the second sealing portion 46 which function as the sealing portion 51 are integrally joined to each other, thereby sealing the inside of the accommodation portion 50 in a hermetically sealed state.

Specifically, the inner resin layer 32 in the first sealing portion 37 and the inner resin layer 42 in the second sealing portion 46 are integrally joined to each other by ultrasound welding or heat welding, for example. However, a joining method is not limited to the ultrasound welding or the heat welding. For example, high frequency welding or adhesion using an adhesive may be used.

In particular, the first sealing portion 37 and the second sealing portion 46 are subjected to bending molding by using a molding die 70 (to be described later) after being integrally joined to each other. Subsequently, both of these are formed to have the decreased diameter by using a drawing molding die 80 (to be described later).

In this manner, the sealing portion 51 configured to include the first sealing portion 37 and the second sealing portion 46 is in contact with the peripheral wall portion 57 in a close contact state where the sealing portion 51 is densely pressed against the outer peripheral surface of the peripheral wall portion 57 over the entire periphery from the outer side in the radial direction.

A connection portion between a lower end portion of the first sealing portion 37 and a lower end portion of the peripheral wall portion 36 functions as an inner bending portion 52 generated through the drawing molding. In addition, a connection portion between a lower end portion of the second sealing portion 46 and an outer peripheral edge portion of the bottom wall portion 45 functions as an outer bending portion 53 generated through the drawing molding.

Furthermore, the sealing portion 51 has a wrinkle portion 58 that extends in the circumferential direction while repeatedly protruding outward in the radial direction and protruding inward in the radial direction. The wrinkle portion 58 is formed over the entire periphery of the sealing portion 51 so that irregularities are alternately repeated in the radial direction. The wrinkle portion 58 is formed so that a wrinkle depth is deepened toward the opening end side of the sealing portion 51 from the inner bending portion 52 side and the outer bending portion 53 side. Therefore, as illustrated in FIG. 2, the wrinkle portions 58 are mainly concentrated and formed on the opening end side of the sealing portion 51.

Furthermore, as illustrated in FIGS. 2 and 4, the secondary battery 1 according to the present embodiment includes a first electrode plate 60 and a second electrode plate 61, a first electrode terminal plate 62 and a second electrode terminal plate 63, and a first sealant film 64 and a second sealant film 65.

The first electrode plate 60, the second electrode plate 61, the first electrode terminal plate 62, the second electrode terminal plate 63, the first sealant film 64, and the second sealant film 65 are accommodated together with the electrode body 2 inside the accommodation portion 50 in the exterior body 3.

The first electrode plate 60, the first electrode terminal plate 62, and the first sealant film 64 are disposed between the electrode body 2 and the top wall portion 35 in the first laminate member 30. The second electrode plate 61, the second electrode terminal plate 63, and the second sealant film 65 are disposed between the electrode body 2 and the bottom wall portion 45 in the second laminate member 40.

The first electrode plate 60 is formed in a circular shape in a plan view, and is integrally connected to the positive electrode 10 in the electrode body 2. For example, the first electrode plate 60 is formed of a metal material such as aluminum and stainless steel to have a diameter smaller than that of the electrode body 2, and is disposed coaxially with the battery axis O.

The first electrode plate 60 is disposed to overlap the eighth-stage positive electrode main body 12 of the positive electrode 10 in the electrode body 2, and the positive electrode terminal tab 14 is welded to the lower surface facing the electrode body 2 side by ultrasound welding, for example. In this manner, the first electrode plate 60 is integrally connected to the positive electrode 10.

For example, the first electrode terminal plate 62 is formed of a metal material such as nickel into a circular shape in a plan view which has a diameter smaller than that of the first electrode plate 60, and is disposed to overlap the upper surface facing the first laminate member 30 side in the first electrode plate 60. Then, the first electrode terminal plate 62 is integrally fixed to the upper surface of the first electrode plate 60 by welding such as resistance welding, for example. The first electrode terminal plate 62 functions as an external connection terminal of the positive electrode 10.

The top wall portion 35 of the first laminate member 30 has a first through-hole 35a having a circular shape in a plan view through which the first electrode terminal plate 62 is exposed outward. The first through-hole 35a is formed to vertically penetrate a central portion in the top wall portion 35, and is formed coaxially with the battery axis O.

The first sealant film 64 is formed in an annular shape that surrounds the first electrode terminal plate 62 from the outer side in the radial direction, and in a state of surrounding the first electrode terminal plate 62, the first sealant film 64 is disposed coaxially with the battery axis O between the first electrode terminal plate 62 and the top wall portion 35 of the first laminate member 30.

The first sealant film 64 is heat-welded to each of the inner resin layer 32 of the top wall portion 35 in the first laminate member 30 and the upper surface of the first electrode plate 60. In this manner, the first electrode plate 60 is heat-welded to the top wall portion 35 of the first laminate member 30 via the first sealant film 64.

For example, the first sealant film 64 is formed of a thermoplastic resin such as polyethylene and polypropylene of polyolefin, or is formed of polypropylene reinforced with a non-woven fabric.

The first electrode plate 60, the first electrode terminal plate 62, and the first sealant film 64 are formed as described above. Accordingly, the entire surface of the first electrode terminal plate 62 is exposed upward through the first through-holes 35a.

As illustrated in FIGS. 2 and 4, the second electrode plate 61, the second electrode terminal plate 63, and the second sealant film 65 are similarly formed and disposed as in the first electrode plate 60, first electrode terminal plate 62, and first sealant film 64 which are described above.

The second electrode plate 61 is formed in a circular shape in a plan view, and is integrally connected to the negative electrode 20 in the electrode body 2. For example, the second electrode plate 61 is formed of a metal material such as copper, has a diameter smaller than that of the electrode body 2, and is disposed coaxially with the battery axis O. The second electrode plate 61 is disposed to overlap the eighth-stage negative electrode main body 22 of the negative electrode 20 in the electrode body 2, and the negative electrode terminal tab 24 is welded to the upper surface facing the electrode body 2 side by ultrasound welding, for example. In this manner, the second electrode plate 61 is integrally connected to the negative electrode 20.

For example, the second electrode terminal plate 63 is formed of a metal material such as nickel into a circular shape in a plan view which has a diameter smaller than that of the second electrode plate 61, and is disposed on the lower surface facing the second laminate member 40 side in the second electrode plate 61. Then, the second electrode terminal plate 63 is integrally fixed to the lower surface of the second electrode plate 61 by welding such as resistance welding, for example. The second electrode terminal plate 63 functions as an external connection terminal of the negative electrode.

The bottom wall portion 45 of the second laminate member 40 has a second through-hole 45a having a circular shape in a plan view through which the second electrode terminal plate 63 is exposed outward. The second through-hole 45a is formed to vertically penetrate a central portion in the bottom wall portion 45, and is formed coaxially with the battery axis O.

The second sealant film 65 is formed in an annular shape that surrounds the second electrode terminal plate 63 from the outer side in the radial direction, and in a state of surrounding the second electrode terminal plate 63, the second sealant film 65 is disposed coaxially with the battery axis O between the second electrode terminal plate 63 and the bottom wall portion 45 of the second laminate member 40.

The second sealant film 65 is heat-welded to each of the inner resin layer 42 of the bottom wall portion 45 in the second laminate member 40 and the lower surface of the second electrode plate 61. In this manner, the second electrode plate 61 is heat-welded to the bottom wall portion 45 of the second laminate member 40 via the second sealant film 65.

The second sealant film 65 is formed of a thermoplastic resin such as polyethylene and polypropylene of polyolefin, or is formed of polypropylene reinforced with a non-woven fabric, as in the first sealant film 64.

The second electrode plate 61, the second electrode terminal plate 63, and the second sealant film 65 are formed as described above. Accordingly, the entire surface of the second electrode terminal plate 63 is exposed downward through the second through-hole 45a.

### (Manufacturing Method of Secondary Battery)

Next, a method of bending and drawing the sealing portion 51 in manufacturing the secondary battery 1 configured as described above will be described.

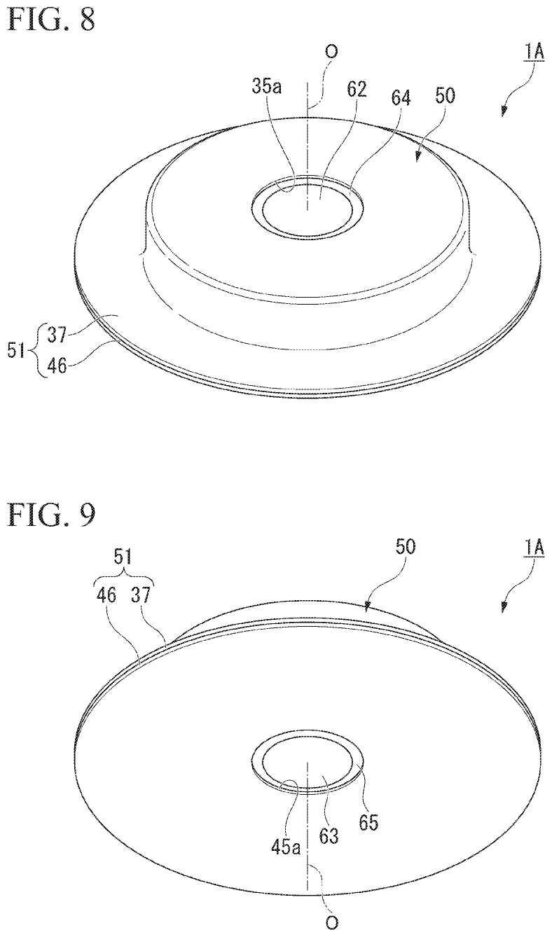

First, as illustrated in FIGS. 8 and 9, the electrode body 2 is accommodated inside the accommodation portion 50 in the exterior body 3. In a state of being filled with the electrolyte solution, a step is performed to integrally join the first sealing portion 37 and the second sealing portion 46 to each other by ultrasound welding.

In this manner, the first sealing portion 37 and the second sealing portion 46 are integrally joined to each other. Accordingly, it is possible to obtain a molding-unfinished battery 1A including the sealing portion 51 formed in an annular shape.

In this stage, the entire surface of the first electrode terminal plate 62 is exposed upward through the first through-hole 35a. In addition, the entire surface of the second electrode terminal plate 63 is exposed downward through the second through-hole 45a.

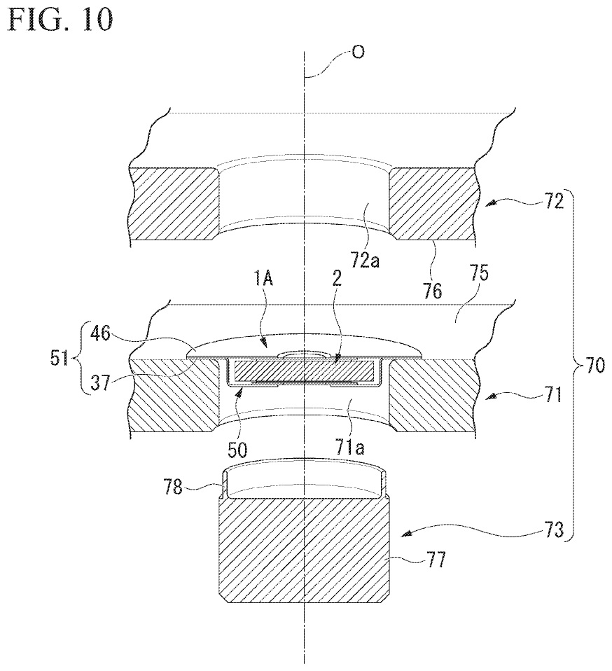

Next, a step of bending and molding the sealing portion 51 is performed using the molding die 70 illustrated in FIG. 10.

The molding die 70 includes a first die 71 that supports the molding-unfinished battery 1A, a second die 72 disposed above the first die 71 and capable of moving toward and away from the first die 71 in the direction of the battery axis O, and a punch portion 73 disposed to be movable relative to the first die 71 and the second die 72 in the direction of the battery axis O.

The first die 71 has a first molding hole 71a that penetrates the first die 71 in the direction of the battery axis O. The first molding hole 71a is formed in a circular shape in a plan view, and is disposed coaxially with the battery axis O. The upper surface of the first die 71 serves as a placement surface 75 by which the sealing portion 51 is supported.

The second die 72 has a second molding hole 72a that penetrates the second die 72 in the direction of the battery axis O. The second molding hole 72a is formed in a circular shape in a plan view which has the diameter the same as that of the first die 71, and is disposed coaxially with the battery axis O. The lower surface of the second die 72 serves as a pressing surface 76 which can press the sealing portion 51 from above between the lower surface of the second die 72 and the placement surface 75.

The punch portion 73 is disposed below the first die 71, and is lifted with respect to the first die 71 and the second die 72. In this manner, the punch portion 73 can enter the inside of the first molding hole 71a and the second molding hole 72a from below.

The punch portion 73 includes a cylindrical punch portion main body 77 having the outer diameter smaller than the inner diameter of the first molding hole 71a and the second molding hole 72a, and an annular molding portion 78 formed to protrude upward from the upper surface of the punch portion main body 77. The molding portion 78 is formed so that the inner diameter is the same as the outer diameter of the accommodation portion 50 and an outer diameter is smaller than the outer diameter of the punch portion main body 77. In addition, the protruding length (length along the direction of the battery axis O) of the molding portion 78 is the same as the height of the accommodation portion 50.

In a case where the molding die 70 configured as described above is used to bend and mold the sealing portion 51, first, as illustrated in FIG. 10, in a state where the accommodation portion 50 faces the punch portion 73 side, the molding-unfinished battery 1A is placed on the first die 71. In this manner, the accommodation portion 50 is disposed inside the first molding hole 71a, and the annular sealing portion 51 is placed on the placement surface 75.

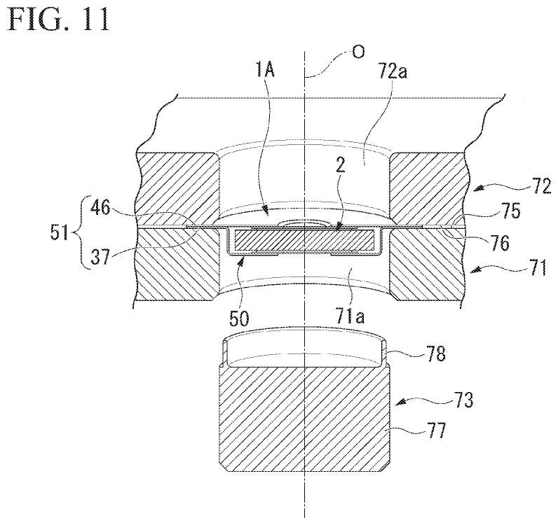

Next, as illustrated in FIG. 11, the second die 72 is moved closer to the first die 71 from above, and the second die 72 is superimposed on the first die 71 with the sealing portion 51 interposed therebetween in the direction of the battery axis O. In this manner, the sealing portion 51 can be clamped and fixed between the placement surface 75 of the first die 71 and the pressing surface 76 of the second die 72.

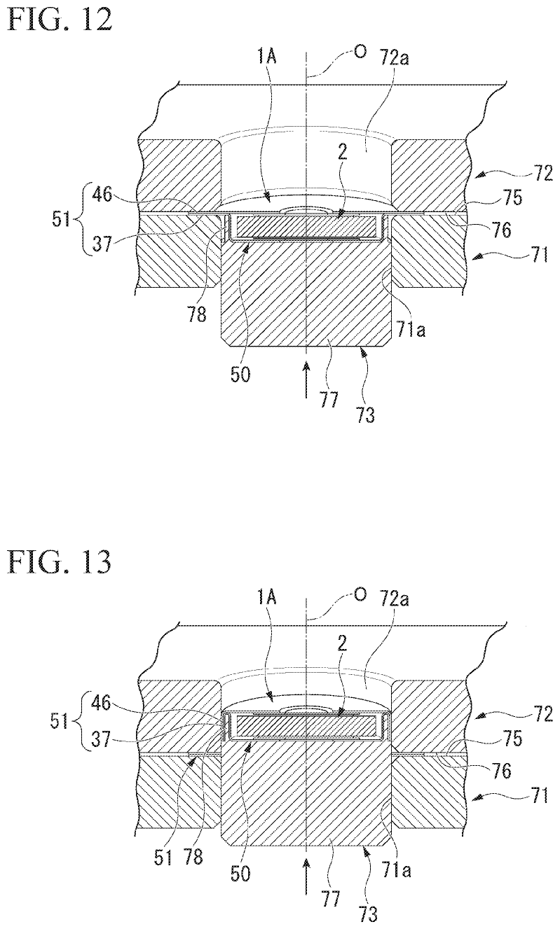

Next, as illustrated in FIG. 12, the punch portion 73 is moved and lifted from below the first die 71 with respect to the first die 71 and the second die 72 which are combined with each other. In this manner, the punch portion 73 can be further moved and lifted after the punch portion 73 enters the inside of the first molding hole 71a, and the molding portion 78 can be brought into contact with the sealing portion 51 from below.

Then, the punch portion 73 is further moved and lifted. Accordingly, as illustrated in FIG. 13, the molding portion 78 can be used to lift the sealing portion 51. The inner surface of the second molding hole 72a and the outer surface of the molding portion 78 can be used so that the sealing portion 51 is bent and molded into a cylindrical shape.

In addition, an upper end edge of the punch portion main body 77 is moved to above a lower end edge of the second molding hole 72a. In this manner, the sealing portion 51 can be cut between the upper end edge and the lower end edge, and a portion of the sealing portion 51 clamped between the placement surface 75 and the pressing surface 76 can be separated.

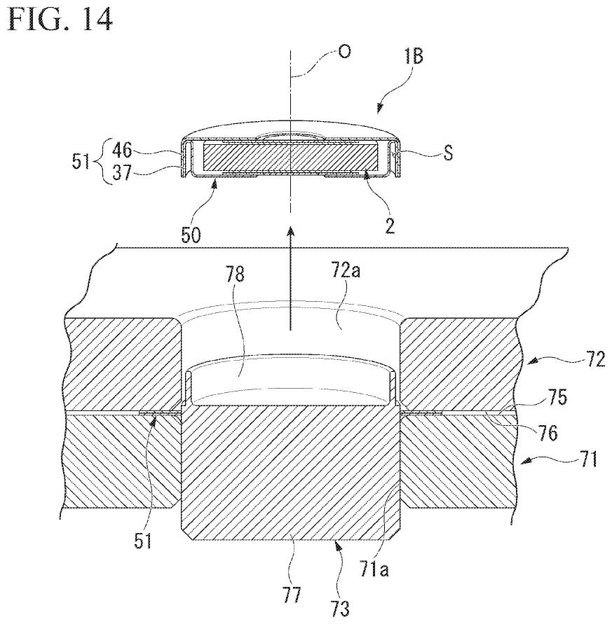

In this manner, as illustrated in FIG. 14, it is possible to obtain a molding-finished battery 1B in which the sealing portion 51 is bent into a cylindrical shape to surround the accommodation portion 50.

However, in the molding-finished battery 1B, the sealing portion 51 is bent and molded using the molding portion 78 of the punch portion 73. Therefore, an annular gap portion S is defined between the accommodation portion 50 and the sealing portion 51.

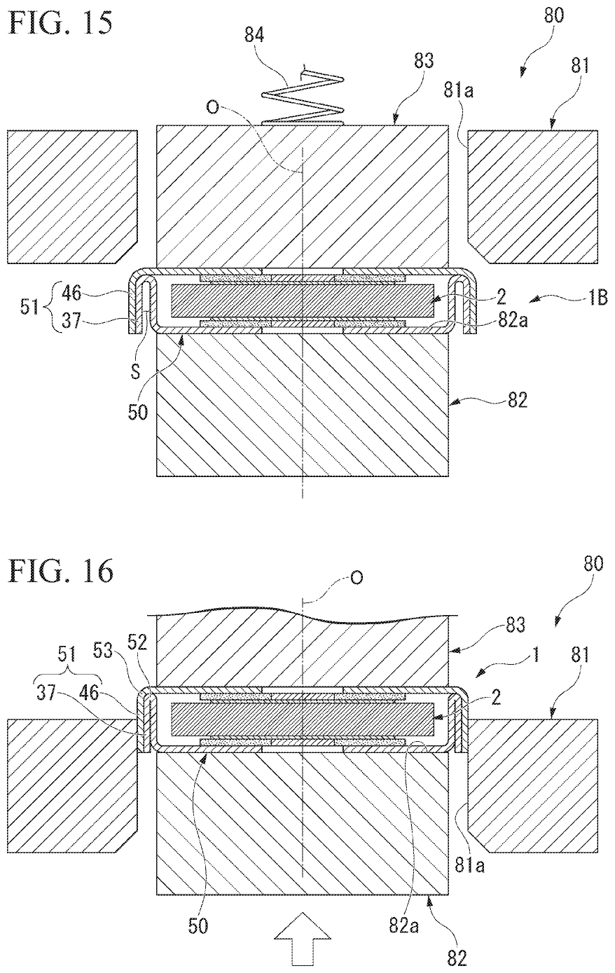

Next, a step of filling the above-described annular gap portion S is performed so that the sealing portion 51 is subjected to drawing molding inward in the radial direction by using the drawing molding die 80 illustrated in FIG. 15.

The drawing molding die 80 includes a first drawing die 81, a second drawing die 82 movable relative to the first drawing die 81 in the direction of the battery axis O, and a movable jig 83 clamping and fixing the molding-finished battery 1B with the second drawing die 82 in the direction of the battery axis O and movable together with the second drawing die 82 in the direction of the battery axis O.

The first drawing die 81 has a drawing hole 81a that penetrates the first drawing die 81 along the direction of the battery axis O. The drawing hole 81a is formed in a circular shape in a plan view, and is disposed coaxially with the battery axis O. The inner diameter of the drawing hole 81a corresponds to a size obtained by adding twice the thickness of the sealing portion 51 to the outer diameter of the accommodation portion 50.

The second drawing die 82 is formed in a circular cylinder-shape having the outer diameter smaller than the inner diameter of the drawing hole 81a, and is disposed coaxially with the battery axis O. The upper surface of the second drawing die 82 serves as a placement surface 82a on which the molding-finished battery 1B is placed.

The movable jig 83 can be inserted into the drawing hole 81a from above. For example, the movable jig 83 can use a biasing force of a biasing member 84 such as a coil spring, and can clamp and fix the molding-finished battery 1B placed on the placement surface 82a with the second drawing die 82 by using predetermined stress.

The movable jig 83 is movable together with the second drawing die 82 in the direction of the battery axis O while maintaining a fixed state of the molding-finished battery 1B.

When the drawing molding of the sealing portion 51 is performed using the drawing molding die 80 configured as described above, as illustrated in FIG. 15, the molding-finished battery 1B is placed on the placement surface 82a of the second drawing die 82. Thereafter, the molding-finished battery 1B is clamped and fixed with the second drawing die 82 by the movable jig 83.

Next, as illustrated in FIG. 16, the second drawing die 82 and the movable jig 83 are moved and lifted to the first drawing die 81. In this manner, the molding-finished battery 1B can enter into the inside of the drawing hole 81a. While the sealing portion 51 is subjected to the drawing molding by using the inner surface of the drawing hole 81a, the molding-finished battery 1B is movable to pass through the inside of the drawing hole 81a.

As a result, an external force can be applied to the sealing portion 51 so that the diameter of the whole sealing portion 51 is decreased inward in the radial direction, and the whole sealing portion 51 can be subjected to the drawing molding. Therefore, the above-described annular gap portion S can be filled, and the sealing portion 51 can be brought into close contact with the peripheral wall portion 57 in the accommodation portion 50 from the outer side in the radial direction. Accordingly, it is possible to obtain the secondary battery 1 illustrated in FIG. 1.

Through the above-described drawing molding, the wrinkle portion 58 is formed over the entire periphery in the sealing portion 51. In addition, during the drawing molding, the sealing portion 51 is subjected to deeper drawing molding toward the opening end side of the sealing portion 51. Accordingly, the wrinkle portion 58 is formed so that the wrinkle depth is deepened toward the opening end side. In addition, even in a case where the length (height) of the sealing portion 51 along the direction of the battery axis O is long, the sealing portion 51 can be properly formed through the drawing molding. The sealing portion 51 is easily brought into contact with the peripheral wall portion 57 without forming a gap between the peripheral wall portion 57 and the sealing portion 51.

### (Operation of Secondary Battery)

According to the secondary battery 1 configured as described above, as illustrated in FIG. 2, the first electrode terminal plate 62 fixed to the first electrode plate 60 is exposed outward, and the second electrode terminal plate 63 fixed to the second electrode plate 61 is exposed outward. Therefore, each of the first electrode terminal plate 62 and the second electrode terminal plate 63 can function as an external connection terminal. In this manner, the secondary battery 1 can be used by using the first electrode terminal plate 62 and the second electrode terminal plate 63.

In particular, in the secondary battery 1 according to the present embodiment, the sealing portion 51 that seals the inside of the accommodation portion 50 is bent along the peripheral wall portion 57 in the accommodation portion 50, and is brought into contact with the peripheral wall portion 57 from the outer side in the radial direction. In this manner, the sealing portion 51 can be disposed to surround the peripheral wall portion 57 without forming the annular gap portion S (refer to FIG. 15) between the peripheral wall portion 57 and the sealing portion 51. Therefore, as much as the above-described gap portion S can be omitted, the diameter of the whole secondary battery 1 can be decreased, compared to the diameter in the related art.

Moreover, the diameter of the whole secondary battery 1 can be decreased without changing the size of the accommodation portion 50 that accommodates the electrode body 2. Accordingly, a ratio of a volume occupied by the electrode body 2 to a volume of the whole secondary battery 1 can be improved. Therefore, it is possible to achieve improved volumetric efficiency.

In addition, the exterior body 3 is formed using the first laminate member 30 and the second laminate member 40 which are thin. Accordingly, each thickness itself of the peripheral wall portion 57 and the sealing portion 51 can be decreased. In this regard, it is also easy to decrease the diameter of the secondary battery 1.

As described above, according to the secondary battery 1 of the present embodiment, it is possible to provide the laminate-type secondary battery which can achieve the decreased diameter and the further improved volumetric efficiency. Therefore, it is possible to provide the high performance secondary battery 1 which can achieve a decreased diameter, a decreased size, a decreased weight, and a higher volume capacity density.

Furthermore, for example, the sealing portion 51 is configured so that the first laminate member 30 and the second laminate member 40 are joined to each other by heat welding, and moreover, the sealing portion 51 is bent along the peripheral wall portion 57. Therefore, it is possible to effectively prevent external disturbances such as dust and water from entering the inside of the accommodation portion 50 from the outside through the portion between the first laminate member 30 and the second laminate member 40. Therefore, it is possible to provide the secondary battery 1 which shows stable operation reliability.

Furthermore, the wrinkle portion 58 can be used to absorb stress strain generated when the sealing portion 51 is bent. Accordingly, the sealing portion 51 can be formed through the drawing molding. Therefore, the sealing portion 51 can be bent while an equal external force is applied over the entire periphery of the sealing portion 51, and the whole sealing portion 51 can be brought into uniform contact with the peripheral wall portion 57. Therefore, it is possible to achieve the further decreased diameter of the secondary battery 1.

While preferred embodiments of the invention have been described and illustrated above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, in the above-described embodiment, the secondary battery 1 has been described as an example of the electrochemical cell. However, the present invention is not limited to this case, and may adopt a capacitor (for example, a lithium ion capacitor) or a primary battery, for example.

Furthermore, in the above-described embodiment, the second electrode plate 61 is formed of copper. However, the second electrode plate 61 may be formed of nickel, for example. In this case, the second electrode terminal plate 63 can be omitted. That is, the electrode terminal plate is not always essential on the negative electrode side, and may not be provided. In this case, the second electrode plate 61 itself can function as the external connection terminal on the negative electrode side.

Furthermore, the whole exterior body 3 is not necessarily formed of the laminate film, and at least the sealing portion 51 may be formed of the laminate film.

Furthermore, in the above-described embodiment, the secondary battery 1 having the circular shape in a plan view has been described as an example. However, the shape of the secondary battery 1 may be appropriately changed. For example, the secondary battery may have an oval shape in which a linear portion and a semicircular portion are combined with each other in a plan view. In this case, the shape of the electrode body 2 may be formed in the oval shape in a plan view which corresponds to the outer shape of the secondary battery.

Furthermore, in the above-described embodiment, the peripheral wall portion 36 of the first laminate member 30 functions as the peripheral wall portion 57 serving as the accommodation portion 50. However, the present invention is not limited to this case.

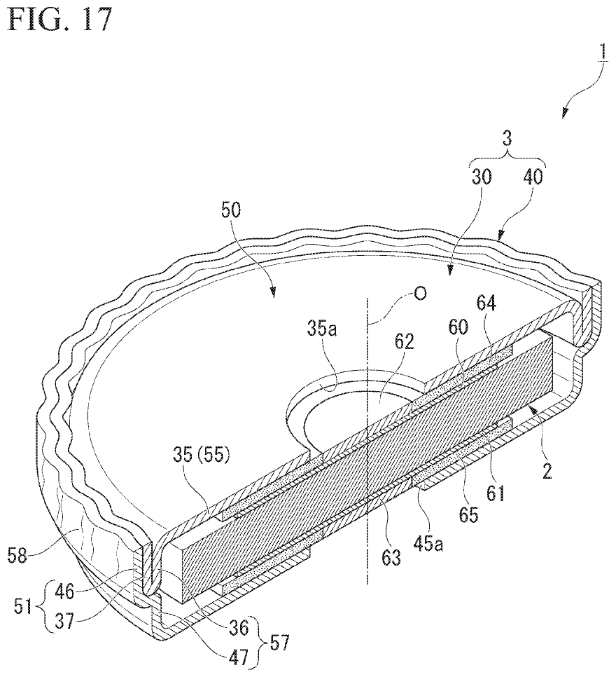

For example, as illustrated in FIG. 17, the second laminate member 40 is formed to have the peripheral wall portion 47, and the secondary battery 90 may be configured so that the peripheral wall portion 47 and the peripheral wall portion 36 of the first laminate member 30 configure the peripheral wall portion 57 of the accommodation portion 50.

In this case, the sealing portion 51 configured to include the first sealing portion 37 and the second sealing portion 46 may be formed to surround the peripheral wall portion 36 of the first laminate member 30 over the entire periphery from the outer side in the radial direction, and the sealing portion 51 may be brought into contact with the peripheral wall portion 36 from the outer side in the radial direction. Even in the case of the secondary battery 90 configured in this way, similar operational effects can be achieved.

### INDUSTRIAL APPLICABILITY

According to the present invention, it is possible to provide a high performance electrochemical cell which can achieve a decreased diameter, a decreased size, a decreased weight, and a higher volume capacity density. Accordingly, industrial applicability can be realized.

What is claimed is:

1. An electrochemical cell comprising:
an electrode body that has a plurality of electrodes stacked on each other in a direction of a battery axis; and
an exterior body that has a first laminate member and a second laminate member, and that internally accommodates the electrode body,
wherein the exterior body includes
an accommodation portion that is formed by disposing the first laminate member and the second laminate member with the electrode body interposed therebetween in the direction of the battery axis, and that internally accommodates the electrode body, and
a sealing portion in which the first laminate member and the second laminate member are joined to each other in a state where the first laminate member and the second laminate member overlap each other so as to seal an inside of the accommodation portion,
wherein the accommodation portion includes a top wall portion and a bottom wall portion which face each other with the electrode body interposed therebetween in the direction of the battery axis, and a cylindrical peripheral wall portion which surrounds the electrode body from an outer side in a radial direction, and
wherein the sealing portion is formed into a cylindrical shape which is bent along the peripheral wall portion and surrounds the peripheral wall portion over an entire periphery from the outer side in the radial direction, and is in contact with the peripheral wall portion from the outer side in the radial direction.

2. The electrochemical cell according to claim 1,
wherein the sealing portion has a wrinkle portion extending in a circumferential direction over the entire periphery of the sealing portion while repeatedly protruding outward in the radial direction and protruding inward in the radial direction.

3. The electrochemical cell according to claim 2,
wherein the wrinkle portion is formed so that a wrinkle depth is deepened toward an opening end side in the sealing portion.
